(19) United States
(12) Patent Application Publication
(10) Pub. No.: US 2008/0291023 A1
(43) Pub. Date: Nov. 27, 2008

(54) RFID Discovery, Tracking, and Provisioning of Information Technology Assets

(75) Inventors: William L. Anderson, Redmond, WA (US); David C. James, Bothell, WA (US)

Correspondence Address: LEE & HAYES PLLC, 421 W RIVERSIDE AVENUE SUITE 500, SPOKANE, WA, 99201, US

(73) Assignee: MICROSOFT CORPORATION, Redmond, WA (US)

(21) Appl. No.: 11/753,552

(22) Filed: May 24, 2007

(51) Int. Cl. G08B 13/14

(52) U.S. Cl. 340/572.1; 340/10.1

(57) ABSTRACT

Techniques for discovery, tracking, and provisioning of information technology (IT) assets are described. In one implementation, a detection region for radio frequency identifier (RFID) signals is monitored, and any RFID signals associated with IT assets within the detection region are sensed. A detected RFID signal is analyzed to obtain identifying information regarding the IT asset. The identifying information is formatted into an event record, and the event record is stored in a memory. In alternate embodiments, the event record may be further analyzed to determine whether the IT asset complies with a policy specification associated with the IT asset, and a notification of noncompliance may be issued if the IT asset does not comply with the policy specification.

### BACKGROUND

Enterprises of all sizes use information technology (IT) assets, including computers, printers, peripherals, personal digital assistants, and a variety of similar devices. Maintaining and tracking these assets can be challenging, particularly for large organizations. The problem may be further compounded as the IT assets are used by a large number of employees that may move among a variety of different facilities, beyond corporate premises, and around the globe.

Due to their ease of portability, IT assets may be frequently misplaced or even stolen. Millions of dollars are spent by organizations either trying to locate these assets, or to purchase additional assets as replacements. Enterprises also typically spend a significant amount of time and expense provisioning these devices with software and appropriate information because of the manual processes involved. When an asset reaches retirement age, it may be necessary to “find” the asset in order to reallocate its software to avoid unnecessary license and purchase costs. Even an asset that hasn't been stolen costs money.

Therefore, systems and methods that improve an organization's efficiency at discovering and tracking IT assets, that reduce losses of IT assets, and that improve the process of provisioning IT assets with the appropriate software and configuration information, would have considerable utility.

### SUMMARY

Techniques for discovery, tracking, and provisioning of information technology (IT) assets are disclosed herein. In one implementation, a detection region for radio frequency identifier (RFID) signals is monitored, and any RFID signals associated with IT assets within the detection region are sensed. A detected RFID signal is analyzed to obtain identifying information regarding the IT asset. The identifying information is formatted for storage. In alternate embodiments, the RFID signal may be further analyzed to determine whether the IT asset complies with a local (or location-specific) policy specification associated with the IT asset, and a notification of noncompliance may be issued if the IT asset does not comply with the local policy specification.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the use of the same reference numbers in different figures indicates similar or identical items.

FIG. 1 illustrates an exemplary environment for implementing techniques to discover and track information technology (IT) assets using radio frequency identifier (RFID) tagging.

FIG. 2 is a block diagram of an exemplary computing device and a tool executable on the computing device to perform discovery and tracking of IT assets using RFID tagging in.

FIG. 3 is a flow diagram of an exemplary process for IT asset discovery.

FIG. 4 is a flow diagram of another exemplary process for IT asset discovery.

FIG. 5 is an exemplary system for management of IT assets using RFID tagging.

FIG. 6 is a flow diagram of an exemplary process of discovering and tracking IT assets using the exemplary system of FIG. 5.

FIG. 7 is another exemplary system for monitoring IT assets using RFID tagging.

FIG. 8 is a flow diagram of an exemplary process of monitoring IT assets using the exemplary system of FIG. 7.

### DETAILED DESCRIPTION

The present disclosure describes use of information provided by a radio frequency identifier (RFID) tag located on an IT asset to discover, track, and provision the IT asset. In some embodiments, the RFID tag is placed on the IT asset by a provider, such as an original equipment manufacturer, distributor, supplier, or retailer, prior to delivery to a customer. The provider can also send the customer a list (e.g. a purchase order or the like) of the tags as they correlate to the items ordered. Once the IT asset shows up at the customer's facility (e.g. a receiving and loading area), the customer may use an RFID reader to detect the IT asset, and correlate that device into an IT asset manager. Once in the IT asset manager, the IT asset can be registered and reconciled with the list from the provider using the IT asset manager.

In further embodiments, the IT asset manager may also access a provisioning policy so that once the IT asset is coupled to a network, the IT asset can automatically receive the software/applications that it needs as specified by the provisioning policy. The provisioning policy may be previously stored in (or otherwise accessible to) the IT asset manager, or alternately, may be provided by the RFID tag located on the IT asset. In this way, customers can track and provision IT assets accurately and efficiently, dramatically reducing the costs of managing and processing IT assets.

As used herein, the term radio frequency identifier (RFID) includes any type of tag, system, or device that operates using radio frequency (RF) signals. The RFID information storage mechanism attached to the object may be referred to as a tag, transponder, electronic label, code plate, and various other terms. Although transponder is technically the most accurate, the term most commonly used for these devices throughout this application is the term “tag.”

Data may be contained on the RFID tag in one or more bits for the purpose of providing identification and other information relevant to the IT asset to which the RFID tag is attached. Such RFID devices may incorporate the use of electromagnetic or electrostatic coupling in the radio frequency portion of the spectrum to communicate to or from an RFID tag through a variety of modulation and encodation schemes. For example, in some embodiments, techniques disclosed herein may be used in association with RFID tags that comply with Electronic Product Code (EPC) standards and specifications, such as those RFID tags commercially available from Remote Identity, LLC of Erie, Colo.

### Exemplary Environment

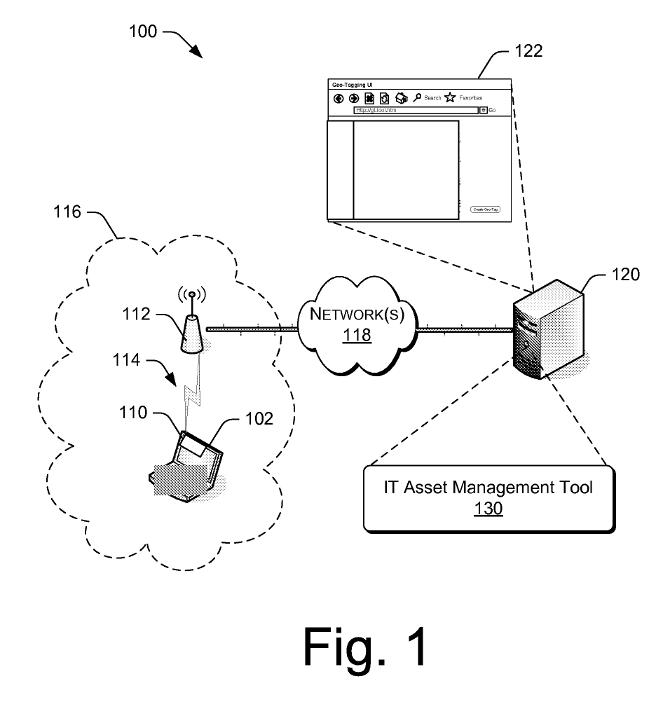

FIG. 1 illustrates an exemplary environment 100 for implementing techniques to discover and track information technology (IT) assets using radio frequency identifier (RFID) tagging. The environment 100 includes an IT asset 102 that is associated with an RFID tag 110. The RFID tag 110 may be affixed to the IT asset 102, or embedded in the electronics, or otherwise associated with the IT asset 102 to uniquely identify that IT asset 102. As shown FIG. 1, the IT asset 102 is illustrated as a portable computer. However, it is noted that the IT asset 102 may be essentially any number of asset types, including computing devices, peripherals, networking devices, communication devices, and the like, as well as individual components of such devices.

An RFID reader 112 is configured to receive signals 114 from the RFID tag 110 within a detection region 116. The term “RFID reader” is intended to include any device that receives RFID signals from the RFID tag 110. The RFID reader 112 may extract and separate information from the RFID signals, including differentiating format definition and error management bits. In some embodiments, digital electronics within the RFID reader 112 perform the actual reading function. These read electronics may also interface to an integral display and may provide a parallel or serial communications interface to a host computer or industrial controller, as described below. In some embodiments, the RFID reader 112 includes a transmitter/receiver pair (or transceiver).

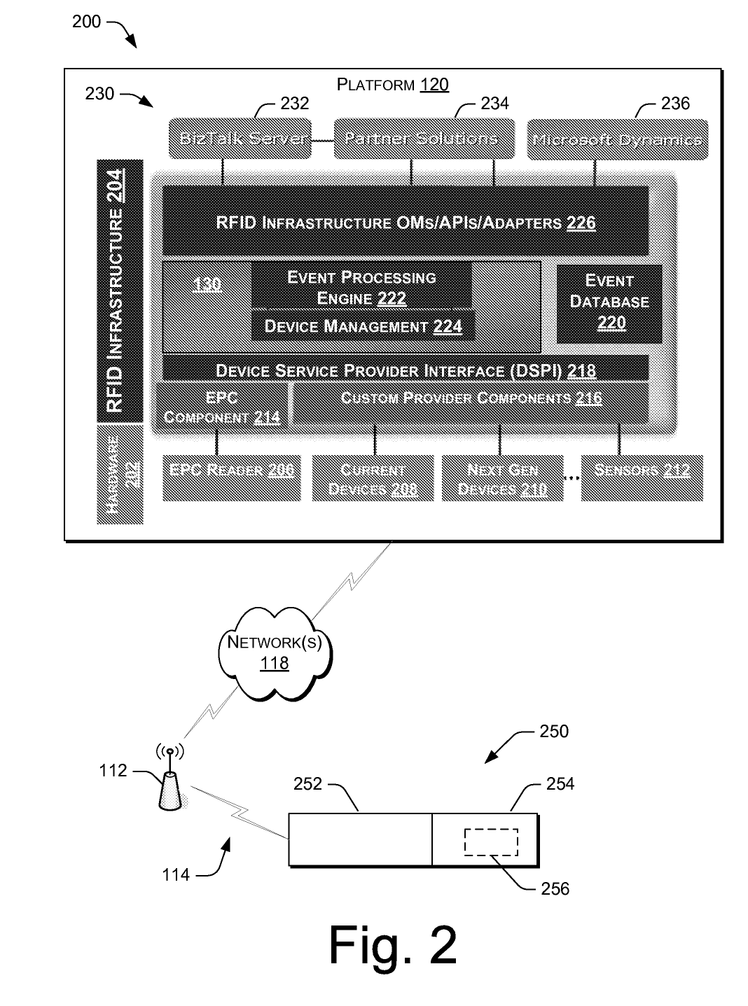

The RFID reader 112 sends the information extracted from the RFID tag 110 via one or more networks 118 to a platform 120. The platform 120 is illustrated in FIG. 1 as a server, but this is merely for representation. The platform 120 may be implemented in any number of suitable ways, including as a desktop computing device, a mainframe, a cluster, a portable computer, and so forth. An exemplary architecture of the platform 120 is illustrated below with reference to FIG. 2.

An IT asset management tool 130 operates on the platform 120 and provides information to a user via a user interface 122. Using the IT asset management tool 130 and the other components of the exemplary environment 100, the user may discover and track the location of the IT asset 102 as it moves within the detection region 116. In a particular embodiment, the IT asset mgmt tool 130 resides on a server (e.g. the platform 120), and stores information regarding IT assets 102 into a database that may be accessed by a user through the user interface 122.

Embodiments of techniques in accordance with the present disclosure may significantly improve an organization's ability to efficiently discover and track IT assets, saving the organization considerable expense associated with these activities and also with the replacement of lost IT assets. Further embodiments may also substantially improve the process of provisioning IT assets with the appropriate software and configuration information.

### Exemplary System

FIG. 2 illustrates various components of an exemplary system 200 that includes the platform 120 and the IT asset management tool 130 executable on the platform 120. In this embodiment, the platform 120 includes a hardware layer 202 and an RFID infrastructure layer 204. An EPC reader 206 of the hardware layer 202 receives incoming information (or signals) 114 from the RFID reader 112, and provides the information 114 to an EPC component 214 of the RFID infrastructure layer 204. The EPC component 214 interprets the information to determine the relevant characteristics and identifying information regarding the IT assets 102 detected by the RFID reader 112.

The hardware layer 202 may also include a current devices reader 208, a next generation devices reader 210, and one or more additional sensors 212 that are configured to receive the information 114 from the RFID reader 112 regarding other current devices, next generation (or future) devices, or any other additional device signals, respectively. The current devices reader 208, the next generation devices reader 210, and the sensors 212 may communicate with one or more custom provider components 216 of the RFID infrastructure layer 204.

As further shown in FIG. 2, the EPC reader 206 (and the custom provider components 216) communicate with the IT asset management tool 130 via a device service provider interface (DSPI) 218. The IT asset management tool 130 includes an event processing engine 222 that receives the incoming information (or signals) 114 from the DSPI 218, and stores the information to an event database 220. More specifically, the event processing engine 222 may process and interpret the information from the DSPI 218 (i.e. from the RFID reader 112), and translate the information into meaningful events, prior to storage in the event database 220, or alternately, the raw information from the DSPI 218 (or the RFID reader 112) may be stored in the event database 220 for subsequent processing and interpretation by the IT asset management tool 130. A device management component 224 exchanges information with the event processing engine 222 and the event database 220, and may perform higher level IT asset management functions, such as reconciling arrival of IT assets with purchase orders, checking a status of an IT asset against an expected or authorized status, maintaining an inventory of IT assets, issuing warnings or alerts for IT assets that may be in non-compliance with company policies and procedures, and any other desired higher level management functions.

The IT asset management tool 130 may, in turn, communicate information via one or more RFID infrastructure object models (OMs), application programming interfaces (APIs), and adapters 226 to existing modules 230 that may perform a variety of different functions with such information. For example, the IT asset management tool 130 may communicate information to a business process management tool 232, such as the BizTalk tool available from the Microsoft Corporation of Redmond, Wash. Information may also be communicated to a financial, supply chain, and customer management component 236, such as the Microsoft Dynamics tool, or to a customized, application-specific partner solution 234 that may utilize the IT asset information in any suitable manner.

It will be appreciated that the components of the IT asset management tool 130 may be implemented on a single platform 120 as shown in FIG. 2, or alternately, these components may be distributed over a plurality of devices. In further embodiments, the functionalities of one or more of the components of the IT asset management tool 130 may be combined into one or more utilities that perform the desired functionalities. Overall, the system 200 shown in FIG. 2 advantageously provides a modular, flexible solution that enables the “plugability” of any desired device/reader 112 into the RFID infrastructure 204, and the incorporation of any desired programmatic interfaces 226 to discover, collect, process, filter, and use the RFID data. for any desired purpose.

In some embodiments, the device management component 224 may be an existing process management package. For example, in a particular embodiment, the device management component 224 may be a systems management package known as the System Center Configuration Manager (SCCM) commercially available from Microsoft. Of course, in alternate embodiments, any suitable embodiments of the device management component 224 may be employed.

Generally, program modules executed on the components of the platform 120 include routines, programs, objects, components, data structures, etc., for performing particular tasks or implementing particular abstract data types. These program modules and the like may be executed as a native code or may be downloaded and executed such as in a virtual machine or other just-in-time compilation execution environments. Typically, the functionality of the program modules may be combined or distributed as desired in various implementations.

An implementation of these modules and techniques may be stored on or transmitted across some form of computer-readable media. Computer-readable media can be any available media that can be accessed by a computer. By way of example, and not limitation, computer-readable media may comprise computer storage media that includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium, including paper, punch cards and the like, which can be used to store the desired information and which can be accessed by a computer.

FIG. 2 also depicts an exemplary RFID information unit 250 provided by the RFID tag 110 for use by the IT asset management tool 130. In this embodiment, a first portion 252 of the RFID information unit 250 includes information descriptive of the IT asset 102 with which the RFID tag 110 is associated. For example, the first portion 252 may include a manufacturer name, model number, serial number, media access control (MAC) address, Universally Unique Identifier (UUID), Globally Unique Identifier (GUID), configuration information, component information, and any other desired information descriptive of the IT asset 102. In some embodiments, the descriptive information of the first portion 252 is consistent with the data and meta-data models of the Services Modeling Language Platform (including the Common Model Library) currently being developed by various organizations, and under consideration for standardization by the Distributed Management Task Force of Portland, Oreg.

A second portion 254 of the RFID information unit 250 may include information relevant to the owner or purchaser of the IT asset 102, such as the name of the owner, name of the intended user, intended location of use, and any other desired owner-related information. In a particular embodiment, depending upon the storage capacity and transmission capability of RFID tag 110, the second portion 254 (or the first portion 252) may include a provisioning policy 256 which may be used for provisioning the IT asset 102, as described more fully below.

In operation, an event occurs when incoming data from an RFID tag registers with an RFID reader that meets this data model and has actual data in the above-referenced core physical asset fields (e.g. MAC Address, etc). One reason for this eventing structure is that a company may use the same RFID readers 112 for multiple types of RFID tag data elements, while the IT asset management tool 130 may only be concerned with the particular RFID information units 250 associated with the organization's IT assets 102.

### Exemplary IT Asset Discovery Processes

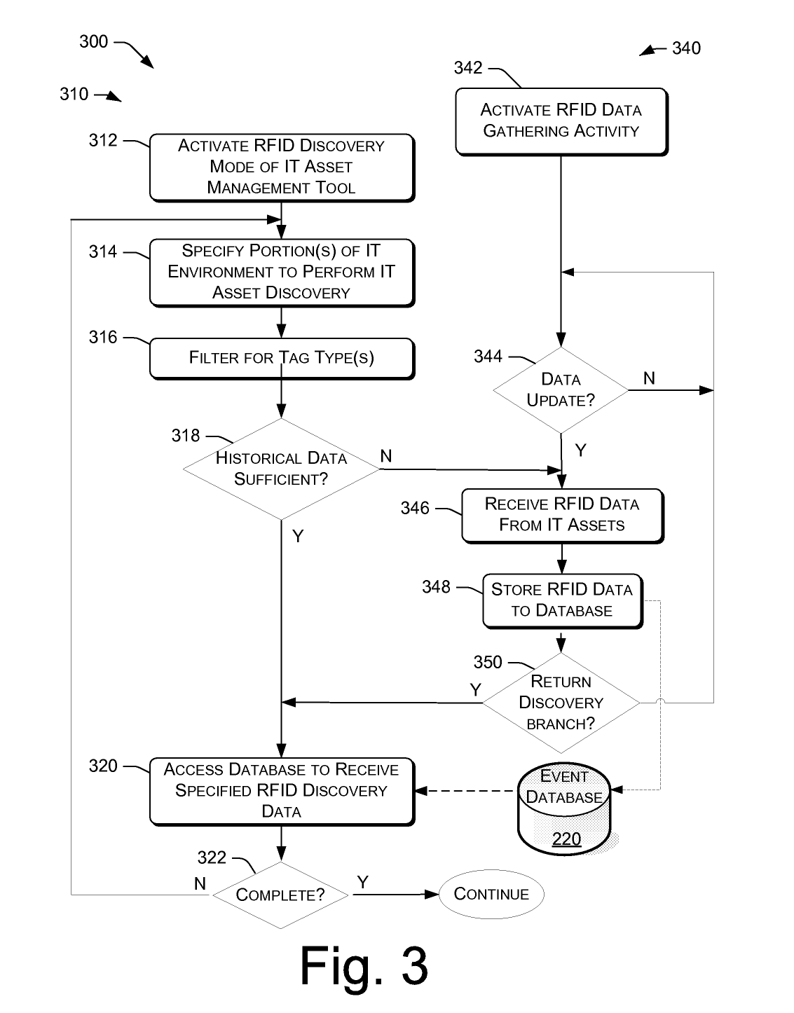

FIG. 3 shows an exemplary process 300 for IT asset discovery using RFID tagging. The process 300 is illustrated as a collection of blocks in a logical flow graph, which represents a sequence of operations that can be implemented in hardware, software, or a combination thereof. In the context of software, the blocks represent computer instructions that, when executed by one or more processors, perform the recited operations. For discussion purposes, the process 300 is described with reference to the exemplary environment 100 shown in FIG. 1, and the exemplary system 200 shown in FIG. 2.

In this embodiment, the process 300 generally includes an asset discovery branch 310 and an RFID data gathering branch 340. In general, the activities associated with the asset discovery branch 310 and the RFID data gathering branch 340 may be performed consecutively or concurrently, or combinations of both. More specifically, in some embodiments, the RFID data gathering branch 340 may be initiated prior to the asset discovery branch 310 in order to populate the event database 220 (FIG. 2) with RFID data from the IT assets of the organization. For example, as shown in FIG. 3, an RFID data gathering activity is activated at 342. At 344, a determination is made whether to perform a data update (e.g. by the RFID infrastructure 204), such as the passage of a predetermined time increment or other suitable update condition. When a data update is desired, RFID data is received from the IT assets of the organization at 346, and are stored to the RFID database 220 at 348. At 350, a determination is made whether the receipt and storage activities 346, 348 were performed based on a request from the asset discovery branch 310, and if so, the process 300 returns to the asset discovery branch 310. The RFID data gathering branch 340 may also return to the data update determination at 344 and continue to gather RFID data and store the RFID data in the event database 220 for future access.

As further shown in FIG. 3, in the asset discovery branch 310, an RFID discovery mode of the IT asset management tool 130 is activated at 312 (e.g. by the asset manager 240). In some embodiments, this may be accomplished by a user inputting appropriate commands via an I/O device 206 of the platform 120. Alternately, the RFID discovery mode may be activated automatically by appropriate system management software, such as during a periodic data collection or routine inspection activity on the IT assets of an organization. At 314, the user (or system management software) may specify one or more portions of the organization's IT environment on which to perform IT asset discovery. For example, it may only be necessary or desirable to perform IT asset discovery within selected portions of the organization (e.g. receiving and loading areas, laboratories, research divisions, manufacturing facilities, etc.). Alternately, of course, the IT asset discovery may be performed over the entire organization.

At 316, filtering for one or more tag types of interest is performed. For example, various RFID signals (or RFID tag types) may be received that are not of interest to the IT asset discovery process 300. Alternately, it may only be necessary or desirable to perform IT asset discovery on one or more particular types of RFID tags (or IT assets) (e.g. laptops, personal digital assistants, etc.). In some embodiments, a system management software may perform relatively frequent asset discoveries of an organization's RFID tags associated with one type of IT asset (e.g. mobile IT assets), and less frequent asset discoveries of RFID tags associated with another type of IT asset (e.g. relatively stationary IT assets, such as desktop computers, routers, servers, mainframes, etc.).

With continued reference to FIG. 3, a determination is made at 318 by the RFID infrastructure 204 (e.g. by the device management component 224) whether historical, previously stored data within the event database 220 is sufficient for the desired IT asset discovery. In some embodiments, for example, the IT asset discovery may be performed to study general movements of IT assets that have occurred in the past, to determine the movement of a particular IT asset during a particular period of time in the past, or some other type of IT asset discovery that only requires historical data. If it is determined that historical data is sufficient at 318, then the event database 220 is accessed (e.g. by the interface unit 230 either through the RFID platform 210, or directly from the event database 220) to receive the specified RFID discovery data at 320.

If it is determined that historical data is not sufficient at 318, then the process 300 proceeds to the RFID data gathering branch 340 to perform a current or up-to-the-moment RFID data retrieval from the IT assets at 346, which is then stored in the RFID database 220 at 348. At the determination 350, the RFID data gathering branch 340 determines that it should return to the asset discovery branch 310, and at 320, the event database 220 is accessed to receive the specified or desired RFID discovery data. At 322, the asset discovery branch 310 determines whether asset discovery is complete. If not, the process 300 returns to the specification activities at 314, and the above-described activities may be repeated as desired. Alternately, if asset discovery is complete at 322, the process 300 may end or continue to other desired operations.

In the exemplary process 300 described above, the asset discovery branch 310 accesses or “pulls” the event data from the event database 220 as desired. In alternate embodiments, however, the RFID data gathering branch 340 may “push” the RFID data to the asset discovery branch 310. In still other embodiments, processes may be conceived that combine both “pulls” and “pushes” as desired.

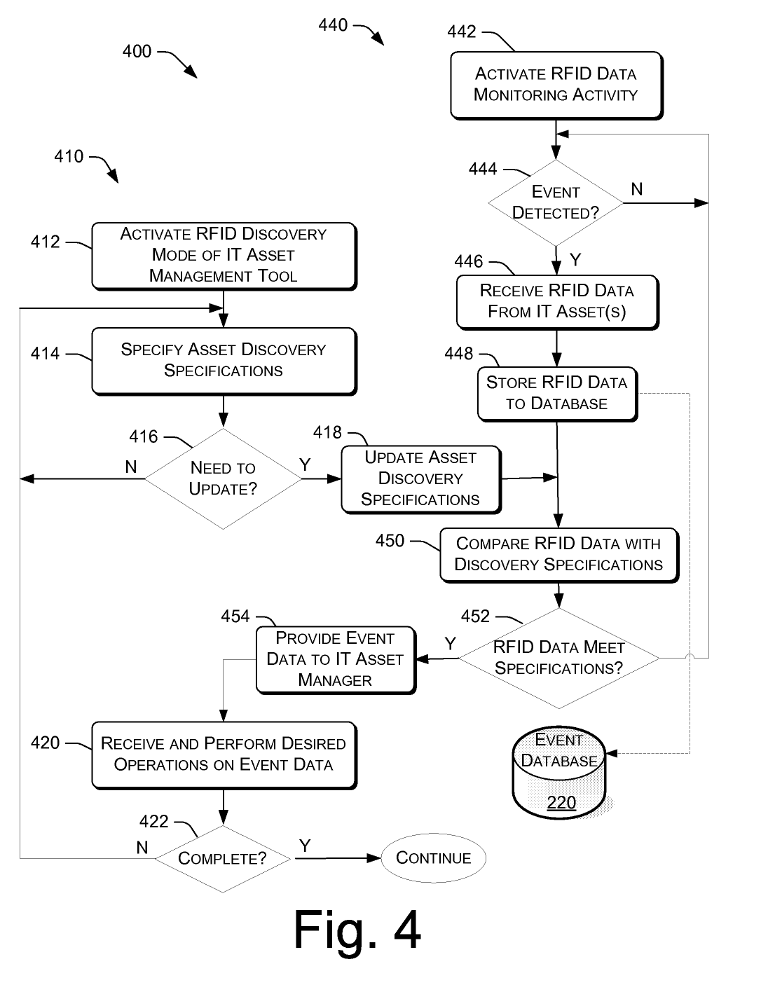

For example, FIG. 4 is a flow diagram of an exemplary process 400 for IT asset discovery in accordance with another embodiment of the invention. The process 400 includes an asset discovery branch 410 and an RFID monitoring branch 440. In this embodiment, the RFID monitoring branch 440 “pushes” the RFID data to the asset discovery branch 410.

An RFID data monitoring is activated at 442. At 444, a determination is made whether an event has been detected, such as by the RFID reader 112 receiving an RFID information unit 250 and providing corresponding RFID data to the RFID platform 210. The RFID monitoring branch 440 continues to monitor for RFID data until an event is detected. When an event is detected, RFID data is received from the IT assets at 446, and may be stored to the event database 220 at 448.

Turning to the asset discovery branch 410, an RFID discovery mode of the IT asset management tool 130 is activated at 412. At 414, IT asset discovery specifications are defined, such as by the user, the system management software, or both. The specifications may include, for example, one or more specified portions of the organization's IT environment on which to perform IT asset discovery (e.g. receiving and loading areas, laboratories, etc.), and filtering options, such as types of IT assets (e.g. laptops, etc.), event types (e.g. an IT asset passing by an RFID reader 112 positioned on a peripheral edge of the IT environment, etc.), or any other desired asset discovery specifications.

At determination is made at 416 whether the discovery specifications need to be updated to the RFID monitoring branch 440. If an update is needed (e.g. when the asset discovery specifications have recently changed), then the asset discovery specifications are updated to the RFID monitoring branch 440 at 418.

At 450, the RFID monitoring branch 440 compares the RFID event data (received at 446) with the asset discovery specifications provided by the asset discovery branch (updated at 418). If the RFID event data satisfies the specifications at 452, then the RFID event data are provided to the IT asset manager at 454. Otherwise, the RFID monitoring branch 440 returns to monitoring for an event at 444.

As further shown in FIG. 4, the asset discovery branch 410 receives the RFID event data, and may perform desired operations and analyses on the RFID event data, at 420. For example, the RFID event data may be displayed to the user via the user interface 122 (FIG. 1), output to an electronic or printed report, identified to the system management software or other software utilities, or any other desired operations. At 422, the asset discovery branch 410 determines whether asset discovery is complete. If not, the process 400 returns to the definition of asset discovery specifications at 414, and the above-described activities may be repeated as desired. Alternately, if asset discovery is complete at 422, the process 400 may end or continue to other desired operations.

Embodiments of methods and systems for IT asset discovery in accordance with the teachings of the present disclosure may provide significant advantages over the prior art. For example, using such methods and systems, RFID tags can be placed on IT assets (e.g. by an original equipment manufacturer, supplier, retailer, etc.) prior to shipment to a customer. The customer may also receive a list of the RFID tags as they correlate to the IT assets ordered. Once the IT assets arrive at the customer's receiving area, one or more RFID readers may detect the IT asset, store the corresponding event data into the event database, and correlate that IT asset into the customer's asset manager (e.g. SCCM). The IT asset can also be registered and reconciled with the list or purchase order in a purchasing/asset management application. In this way, time and expense associated with documenting and reconciling orders with deliveries may be greatly reduced, and the accuracy of these activities improved.

### Alternate Embodiments for Managing and Provisioning IT Assets

It will be appreciated that a variety of alternate embodiments of methods and systems in accordance with the teachings of the present disclosure may be conceived, and the invention is not limited to the particular embodiments described above and shown in the accompanying figures. In the following discussion, several alternate embodiments are described for managing, provisioning, and tracking IT assets.

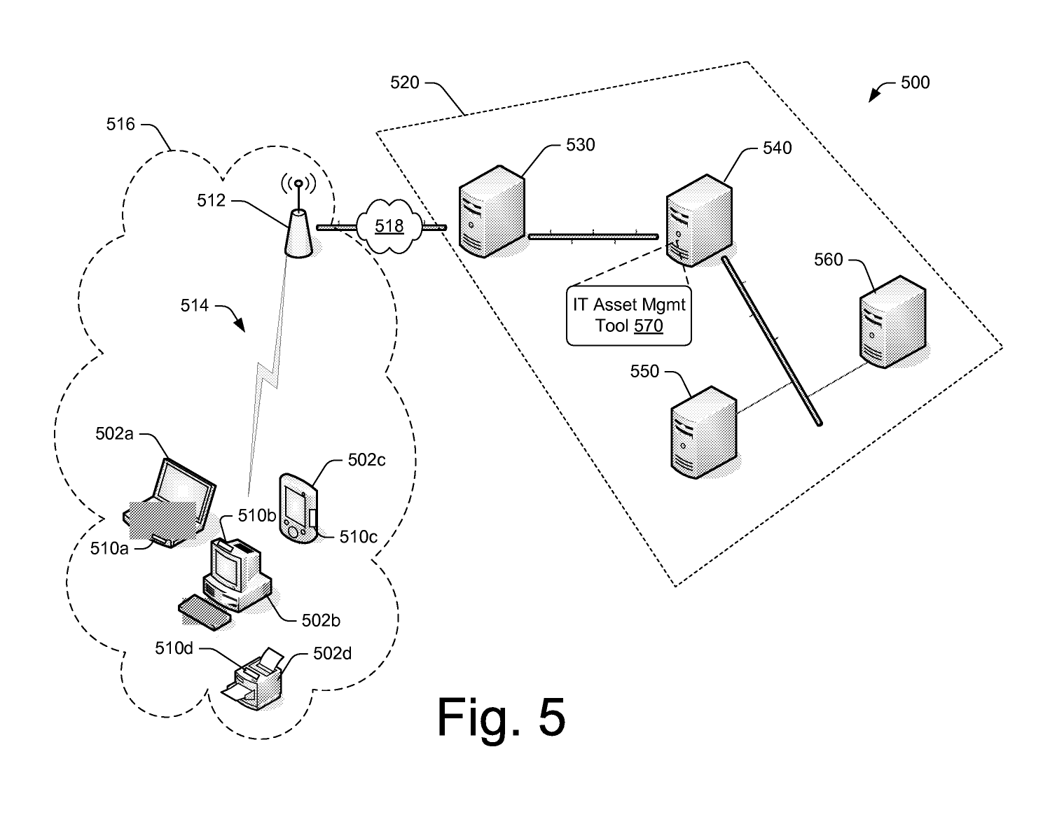

For example, FIG. 5 is an exemplary system 500 for management of IT assets using RFID tagging in accordance with another embodiment of the invention. The system 500 includes an RFID reader 512 configured to receive signals 514 from one or more RFID tags 510 located on RFID assets 502 within a detection region 516. The RFID reader 512 is coupled to an inventory system 520 via a network 518.

In this embodiment, the inventory system 520 includes an RFID platform component 530, an event component 540, a purchasing component 550, and an asset management component 560. An IT asset management tool 570 operates on the inventory system 520, and in this particular embodiment, on the event component 540, and enables the inventory system 520 to manage the IT assets 502 within the detection region 516, as described below.

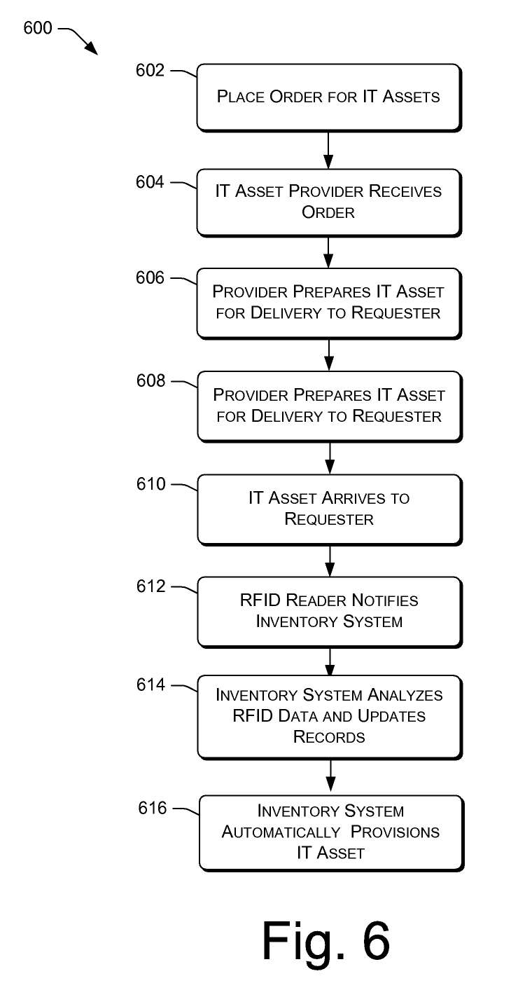

FIG. 6 is a flow diagram of an exemplary method 600 of managing IT assets using the exemplary system 500 of FIG. 5. At 602, an order is placed by an organization for an IT asset, such as a laptop 502a, a computer 502b, a personal digital assistant 502c, a printer 502d, or any other desired type of IT asset. In some embodiments, the order may be accomplished by a user using the purchasing component 550 of the inventory system 520, and may include generating a purchase order for the desired IT asset. The order is received by an IT asset provider at 604. In alternate embodiments, the IT asset provider may be an outside vendor or OEM, or an in-house department or individual responsible for providing IT assets to users within the organization, or any other type of IT asset provider.

At 606, the IT asset provider prepares the IT asset(s) for delivery to the purchaser. This may include affixing an RFID tag 510 to each IT asset, and encoding the RFID tag 510 with relevant information corresponding to the organization's order. For example, as described above with respect to the information unit 250 depicted in FIG. 2, the RFID tag 510 may include information descriptive of the IT asset 502 (e.g. manufacturer, model, serial number, MAC address, UUID, GUID, configuration, etc.), and information specific to the order (e.g. owner, intended user, intended location, order date, requester, provisioning policy, etc.). In a particular embodiment, the RFID tag 510 may be pre-encoded by the manufacturer with information specific to the IT asset 502, and the IT asset provider may prepare the IT asset for delivery by further encoding the RFID tag 510 with information specific to the order placed at 602.

The IT asset 502 arrives to the purchaser at 610. More specifically, as shown in FIG. 5, the IT asset 502 arrives within the detection region 516 and is detected by the RFID reader 512. The detection region 516 may include a receiving area, a loading dock, a mail room, or any other suitable area. At 612, the RFID reader 512 decodes the signals 514 from the RFID tag 510 and transmits appropriate information based on the decoded signals 514 to the inventory system 520, notifying the inventory system 520 of the arrival of the IT asset 502.

As further shown in FIG. 6, at 614, the inventory system 520 may analyze the data from the RFID reader 512 and update records accordingly. More specifically, in the embodiment shown in FIG. 5, the event component 540 of the inventory system 520 may use the IT asset management tool 570 to analyze the information from the RFID reader 512, interpret and reformat this information (if necessary), and if an event of interest is determined (such as arrival of the IT asset 502), provide this information to the purchasing component 550 and the asset management component 560. The IT asset management tool 570 may perform the desired activities and functions as described above with reference to the IT asset management tool 130.

In some exemplary embodiments, to determine whether an event of interest has occurred, the event component 540 may use the IT asset management tool 570 to compare the data received from the RFID platform component 530 with predetermined specifications (such as the order for IT assets placed at 602). If the data satisfies the specifications, then the event component 540 may notify the purchasing component 550 and the asset management component 560 of the arrival of the IT asset 502. The purchasing component 550 may reconcile the order records to reflect and document that the order has been satisfied (or not). Similarly, the asset management component 560 may update appropriate records to reflect the arrival, location, configuration, responsible user, and other desired details regarding the IT asset 502.

In some embodiments, the inventory system 520 also provisions the IT asset 502 at 616. For example, upon updating the appropriate records to reflect the presence and configuration of the IT asset 502 (at 614), a component of the inventory system 520, such as the asset management component 560, may access a provisioning policy associated with the particular IT asset 502. In some embodiments, the provisioning policy is located in a memory of the inventory system 520. Alternately, as described above with respect to FIG. 2, the provisioning policy may be obtained from the RFID tag 110 associated with the IT asset 502.

In a particular embodiment, the asset management component 560 (or other component of the inventory system 520) identifies that the IT asset 502 belongs to a certain cost center or department within the requesting organization. In turn, the inventory system 520 determines that the IT asset 502 is among a collection of assets and components that are intended to receive a specific set of software and configuration information (i.e. a specific provisioning policy). The asset management component 560 may identify the IT asset 502 to a provisioning component, which may be a part of the inventory system 520 (such as the event component 530), or which may be a separate, third party component.

For example, in some embodiments, the asset management component 560 may provide a MAC address or other suitable identifier obtained from the RFID tag 510 associated with the IT asset 502 to a provisioning component, such as a Preboot eXecution (PxE) server, along with an associated provisioning policy. As the new IT asset 502 boots upon a network, a default is set to network boot, and the inventory system 520 contacts the PxE server, boots from this server, and receives its policy instructions, and then provisions the IT asset 502 with the software and settings as specified by the provisioning policy.

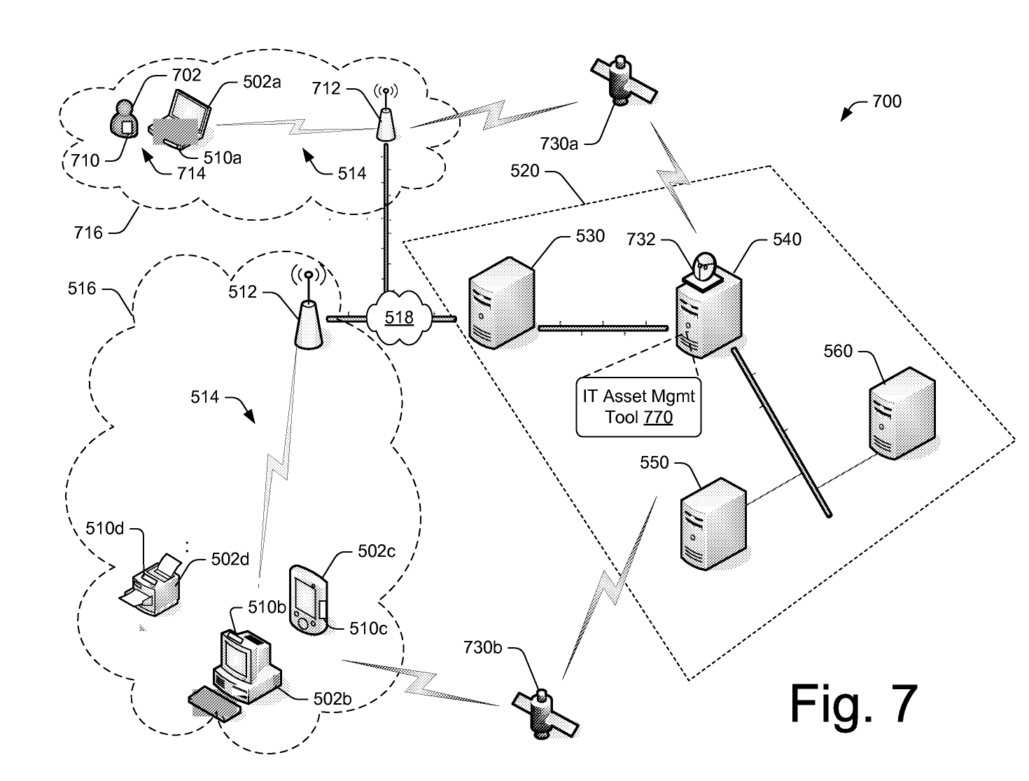

FIG. 7 is an exemplary system 700 for monitoring IT assets using RFID tagging in accordance with yet another embodiment of the invention. It will be appreciated that many of the components of the monitoring system 700 are similar (or identical) to the components of the management system 500 described above with reference to FIG. 5. For the sake of brevity, the complete description of such common components will not be repeated, and only significant differences between the monitoring system 700 and the management system 500 will be described in detail.

In this embodiment, the monitoring system 700 includes a second RFID reader 712 configured to monitor a second detection region 716. When one or more of the IT assets 502 enters the second detection region 716, the signals 514 are received by the second RFID reader 712 and transmitted to the inventory system 520 via the network 518. As further shown in FIG. 7, the second RFID reader 712 may also receive second RFID signals 714 from a second RFID tag 710 located on a user 702. The first RFID reader 512 may also receive the second RFID signals 714 from the second RFID tag 710 when the user 702 is present within the first detection region 516.

In one exemplary embodiment, one or more satellites 730 could be configured to receive signals from one or more of the RFID readers 512, 712 (e.g. satellite 730a), or directly from one or more of the RFID tags 510, 710 (e.g. satellite 730b), and to communicate this information to the inventory system 520, such as to a receiver 732 in operative communication with the event component 540. For embodiments wherein one or more of the RFID tags 510, 710 communicate directly with the satellite 730b, the RFID tags may be “active” tags that broadcast with sufficient power to enable satellite monitoring. Using global location awareness tools like assisted Global Positioning (or GPS), broadband networks, etc., the locations of the IT assets 502 may be monitored and determined via triangulation on a worldwide scale.

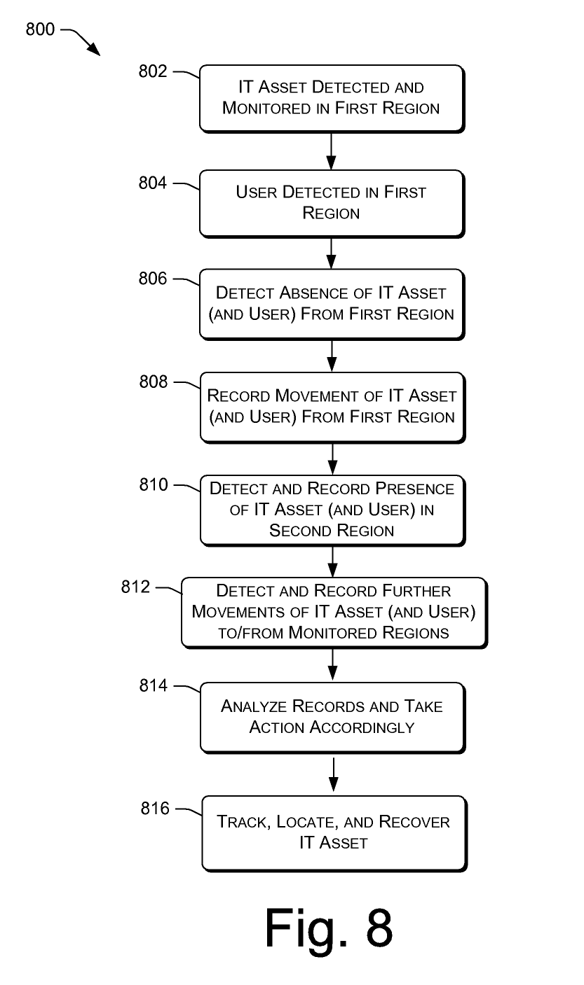

A method 800 of monitoring IT assets using the monitoring system 700 is shown in FIG. 8. At 802, one or more IT assets 502 are detected and monitored within the first detection region 516. The user 702 may enter the first detection region 516 and be detected by the first RFID reader 512 at 804. In alternate embodiments, an RFID reader other than the first RFID reader 512 may be used to detect the presence of the user 702 within the first detection region 512. For example, in some embodiments, the second RFID tag 710 may be affixed to an identification badge worn by the user 702, and access to the first detection region 512 may require the user 702 to scan the identification badge (i.e. the second RFID tag 710) through a scanner to gain entry.

At 806, the absence of the IT asset 502 from the first detection region 512 may be detected by the first RFID reader 512. For example, the user 702 may exit from the first detection region 512 carrying the IT asset 502a, causing the RFID tag 510a on the IT asset 502a to stop registering with the first RFID scanner 512, and the absence of the IT asset 502a to be noted by the IT asset management tool 770. Similarly, the absence of the user 702 from the first detection region 512 may also be detected (e.g. by the first RFID reader 512, a badge reader, etc.), and the corresponding times of these events recorded. A record of the absence of the IT asset 502a may be generated at 808. For example, in one embodiment, a message in the inventory system 520, such as a Desired Configuration Management state message in the asset management component 570, that the IT asset 502a is no longer in policy.

As further shown in FIG. 8, the presence of the RFID asset 502a within the second detection region 716 may be detected and recorded at 810. The presence of the user 702 may also be detected (and recorded). At 812, the movements of the IT asset 502a (and the user 702) may continue to be monitored and recorded as the IT asset 502 (and user 702) move into and out of monitored regions. For example, it will be appreciated that the monitoring system 700 (FIG. 7) may be expanded to include any number of monitored regions, enabling the movements of the IT asset 502a (and user 702) to be continuously monitored and updated as they move about the organization. In some embodiments, the movement of the IT asset 502a may be monitored anywhere there is coverage by satellites 730.

The records of the movements (presence, absence, or both) of the IT asset 502a and the user 702 may be analyzed, and if necessary, appropriate action may be taken at 814. For example, if the movement of the IT asset 502a is correlated with the movement of the user 702 from the first detection region 516 to the second detection region 716, and if it is against policy for the IT asset 502a to be removed from the first detection region 516, then the inventory system 520 (e.g. the IT asset management tool 770) may take various actions, such as sending a message to the user 702 advising that the removal of the IT asset 502a is against policy, alerting a party responsible for monitoring the IT asset 502a of the movement of the IT asset 502a, or any other suitable action. It will be appreciated that, in some embodiments, the appropriate action may also include remaining passive and continuing to monitor and record the movements of the IT asset 502a. For monitoring systems having two or more detection regions (e.g. monitoring system 700), analysis of the movement records of the IT asset(s) 502 may reveal a variety of information, including last known direction of movement, point of departure from an organization's monitored environment, time of absence from the organization's monitored environment, users present within the monitored environment during times of interest, or other desired information.

As further shown in FIG. 8, at 816, it may be desirable to track, locate, and recover the IT asset 502a within a last known detection region. More specifically, the records of the movement of the IT asset 502a may be analyzed to determine the last known detection region in which the IT asset 502a is (or was) present. A possible correlation of the RFID tag 710 of the user 702 with the IT asset 502a can be assessed to better determine the last known person that may have had the IT asset 502a. A party responsible for the IT asset 502a may verify that the IT asset 502a remains within the last known detection region, such as by using a hand scanner to perform a scan of the RFID signals within the last known detection region.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, comprising:
monitoring a detection region for radio frequency identifier (RFID) signals;
sensing an RFID signal associated with an information technology (IT) asset within the detection region;
analyzing the RFID signal to obtain identifying information regarding the IT asset; and
formatting the identifying information for storage.

2. The method of claim 1, wherein analyzing the RFID signal includes analyzing the RFID signal to obtain a provisioning policy associated with the IT asset.

3. The method of claim 2, further comprising provisioning the IT asset in accordance with the provisioning policy.

4. The method of claim 1, further comprising:
specifying one or more IT asset discovery specifications; and
determining whether the RFID signal satisfies the one or more IT asset discovery specifications.

5. The method of claim 1, further comprising:
specifying one or more IT asset discovery specifications; and
determining whether one or more event records previously stored in the memory satisfies the one or more IT asset discovery specifications.

6. The method of claim 1, wherein formatting the identifying information includes formatting the identifying information into an event record, the method further comprising:
analyzing the event record to determine whether the IT asset complies with at least one policy specification associated with the IT asset; and
issuing a notification if the IT asset does not comply with the at least one policy specification.

7. The method of claim 1, further comprising:
sensing a second RFID signal associated with a user badge within the detection region;
analyzing the second RFID signal to obtain second identifying information regarding the user badge; and
formatting the second identifying information for storage.

8. The method of claim 7, further comprising determining a correlation between the RFID signal associated with the IT asset and the second RFID signal associated with the user badge.

9. The method of claim 1, further comprising:
monitoring a second detection region for RFID signals;
sensing the RFID signal associated with the IT asset within the second detection region;
preparing a second event record indicating a presence of the IT asset within the second detection region; and
storing the second event record in a memory.

10. The method of claim 9, further comprising determining a direction of travel of the IT asset based on the sensing of the RFID signal within the first and second detection regions.

11. The method of claim 9, further comprising determining a correlation between (1) movement of the RFID signal associated with the IT asset through the first and second detection regions and (2) movement of a second RFID signal associated with a user badge through the first and second detection regions.

12. A computer readable medium storing computer-executable instructions that, when executed, perform acts comprising:
detecting a radio frequency identifier (RFID) signal emitted by an RFID tag associated with an information technology (IT) asset;
extracting identifying information regarding the IT asset from the RFID signal; and
storing an event record including the identifying information in a memory.

13. The computer readable medium of claim 12, wherein the acts further comprise:
analyzing the event record to determine compliance of the IT asset with at least one policy specification; and
issuing a notification if the IT asset is not in compliance with the at least one policy specification.

14. The computer readable medium of claim 12, wherein the acts further comprise:
detecting a second RFID signal associated with a user badge;
extracting a second identifying information regarding the user badge from the second RFID signal; and
determining a correlation between the IT asset and the user badge.

15. The computer readable medium of claim 12, wherein the acts further comprise extracting a provisioning policy associated with the IT asset from the RFID signal.

16. The computer readable medium of claim 15, wherein the acts further comprise provisioning the IT asset in accordance with the provisioning policy.

17. A system, comprising:
a sensor configured to monitor a detection region for a radio frequency identifier (RFID) signal associated with an IT asset; and
a management component coupled to receive a detection signal from the sensor, the management component being configured to formulate an event record containing identifying information regarding the IT asset obtained from the detection signal.

18. The system of claim 17, wherein the management component is further configured to:
analyze the event record to determine compliance of the IT asset with at least one policy specification; and
issue a notification if the IT asset is not in compliance with the at least one policy specification.

19. The system of claim 17, wherein the sensor is further configured to detect a second RFID signal associated with a user badge, and wherein the management component is further configured to determine a correlation between the IT asset and the user badge.

20. The system of claim 17, wherein the management component is further configured to:
extract a provisioning policy associated with the IT asset from the at least one RFID signal; and
provision the IT asset in accordance with the provisioning policy.
